(19) United States
(12) Patent Application Publication
(10) Pub. No.: US 2018/0108033 A1
(43) Pub. Date: Apr. 19, 2018

(54) CONTENT SCHEDULING METHOD AND APPARATUS IN MULTI-CONTENT REPRODUCING APPARATUS ENVIRONMENT

(71) Applicant: SAMSUNG SDS CO., LTD., Seoul (KR)

(72) Inventors: Young Hyun CHOI, Seoul (KR); Hyun Jung YU, Seoul (KR); Hyun Chul KIM, Seoul (KR); Min Sik CHU, Seoul (KR); Ji Hoon KANG, Seoul (KR); A Hyang HAN, Seoul (KR)

(73) Assignee: SAMSUNG SDS CO., LTD., Seoul (KR)

(21) Appl. No.: 15/785,851

(22) Filed: Oct. 17, 2017

(30) Foreign Application Priority Data
Oct. 17, 2016 (KR) 10-2016-0134106

(51) Int. Cl. G06Q 30/02

(52) U.S. Cl. CPC G06Q 30/0246; H04N 21/812

(57) ABSTRACT

Provided is a content scheduling method performed by a content scheduling apparatus for a plurality of content reproducing apparatuses located at different geographical locations. The method comprises obtaining a total play count of target content, determining a plurality of weight values of the target content, each weight value of the plurality of weight values indicating a preference for the target content with respect to each content reproduction apparatus of the plurality of content reproduction apparatuses, wherein the plurality of weight values are different for at least some of the plurality of content reproduction apparatuses, generating a linear programming model based on the total play count and the plurality of weight values and determining, via a processor, a play count of the target content in each time slot of a plurality of time slots for the each content reproduction apparatus based on the linear programming model.

This application claims the benefit of Korean Patent Application No. 10-2016-0134106, filed on Oct. 17, 2016, in the Korean Intellectual Property Office, the disclosure of which is incorporated herein by reference in its entirety.

### BACKGROUND

### 1. Field

The present inventive concept relates to a content scheduling method and apparatus, and more particularly, to a method and apparatus for scheduling content to improve the effect of content exposure in a content providing system including a plurality of content reproducing apparatuses.

### 2. Description of the Related Art

With the development of display device technology and network technology, outdoor advertising that utilizes various forms of digital signage such as video walls and kiosks is becoming a new trend of advertisement industry.

In outdoor advertising using digital signage, content scheduling is essential to improve the effect of advertisement exposure to a target audience. This is because, in order to improve the exposure effect of advertisement content, the advertisement content should be appropriately placed at each time in consideration of the number of target customers of the advertisement content that varies according to time.

Graphs illustrated in FIGS. 1A and 1B show the difference in the effect of advertisement exposure to a target audience according to content scheduling. If the graphs of FIGS. 1A and 1B are compared with each other, it can be seen that the total number of reproductions of advertisement content is the same, but the advertisement exposure effect is significantly improved when the advertisement content is scheduled in consideration of the number of floating population of a target audience as in FIG. 1B.

However, a conventional outdoor advertising system using digital signage cannot perform content scheduling in consideration of the number of floating population of a target audience due to the absence of a scheduling algorithm. In addition, in order for an outdoor advertising system using a plurality of digital signage devices to perform content scheduling, it is necessary to further consider various characteristics that can affect the content exposure effect, such as the number of floating population of a target audience at the installation location of each digital signage device and at each time and hardware features of each digital signage device. Therefore, it is more difficult to find an optimal scheduling combination.

### SUMMARY

Aspects of the inventive concept provide a scheduling method and apparatus capable of maximizing the effect of content exposure to a target audience in a content providing system including a plurality of content reproducing apparatuses.

Aspects of the inventive concept also provide a scheduling method and apparatus capable of maximizing the effect of content exposure to a target audience by reflecting various preferences of each piece of scheduling target content for each content reproducing apparatus.

Aspects of the inventive concept also provide a linear programming model which produces a scheduling result by reflecting various preferences of scheduling target content for each content reproducing apparatus.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

According to an aspect of the inventive concept, there is provided a content scheduling method performed by a content scheduling apparatus for a plurality of content reproducing apparatuses located at different geographical locations. The method comprises obtaining a total play count of target content, determining a plurality of weight values of the target content, each weight value of the plurality of weight values indicating a preference for the target content with respect to each content reproduction apparatus of the plurality of content reproduction apparatuses, wherein the plurality of weight values are different for at least some of the plurality of content reproduction apparatuses, generating a linear programming model based on the total play count and the plurality of weight values; and determining, via a processor, a play count of the target content in each time slot of a plurality of time slots for the each content reproduction apparatus based on the linear programming model.

According to another aspect of the inventive concept, there is provided a content scheduling apparatus comprising at least one processor, a network interface configured to communicate with a plurality of content reproduction apparatuses, a memory configured to load a computer program to be executed by the at least one processor, and a storage configured to store the computer program which, when executed by the at least one processor, causes the at least one processor to perform operations comprising obtaining a total play count of target content, determining a plurality of weight values of the target content, each weight value of the plurality of weight values indicating a preference for the target content with respect to each content reproduction apparatus of the plurality of content reproduction apparatuses, wherein the plurality of weight values are different for at least some of the plurality of content reproduction apparatuses, generating a linear programming model based on the total play count and the plurality of weight values and determining a play count of the target content in the each time slot for the each content reproduction apparatus based on the linear programming model.

According to another aspect of the inventive concept, there is provided a computer-readable storage medium storing instructions which, when executed by a processor, cause the processor to perform operations comprising obtaining a total play count of target content, determining a plurality of weight values of the target content, each weight value of the plurality of weight values indicating a preference for the target content with respect to each content reproduction apparatus of the plurality of content reproduction apparatuses, wherein the plurality of weight values are different for at least some of the plurality of content reproduction apparatuses, generating a linear programming model based on the total play count and the plurality of weight values, and determining a play count of the target content in the each time slot for the each content reproduction apparatus based on the linear programming model.

### BRIEF DESCRIPTION OF THE DRAWINGS

These and/or other aspects will become apparent and more readily appreciated from the following description of the embodiments, taken in conjunction with the accompanying drawings in which:

FIGS. 1A and 1B are diagrams for explaining the difference in advertisement exposure effect according to content scheduling;

FIG. 2 illustrates the configuration of a content providing system according to an embodiment;

FIG. 3 illustrates the hardware configuration of a content scheduling apparatus according to an embodiment;

FIG. 4 is a functional block diagram of a content scheduling apparatus according to an embodiment;

FIG. 5 is a flowchart illustrating a content scheduling method that can be performed in a single content reproducing apparatus environment according to an embodiment;

FIGS. 6 and 7 illustrate linear programming models that can be used in the single content reproducing apparatus environment;

FIG. 8 is a flowchart illustrating a content scheduling method that can be performed in a multi-content reproducing apparatus environment according to an embodiment;

FIGS. 9A and 9B are diagrams for explaining an operation of determining a preference weight in FIG. 8;

FIGS. 10 and 11 illustrate linear programming models that can be used in the multi-content reproducing apparatus environment; and

FIGS. 12 and 13 are diagrams for explaining a linear programming model that can perform scaling by reflecting nearby store information in the multi-content reproducing apparatus environment.

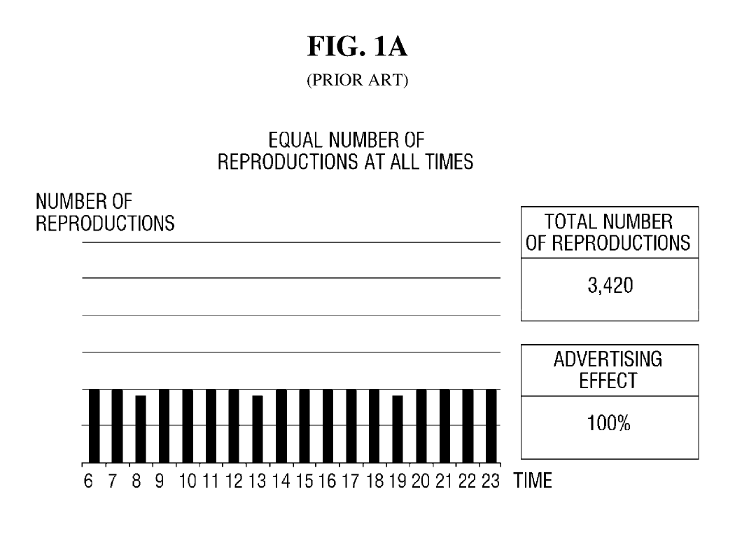

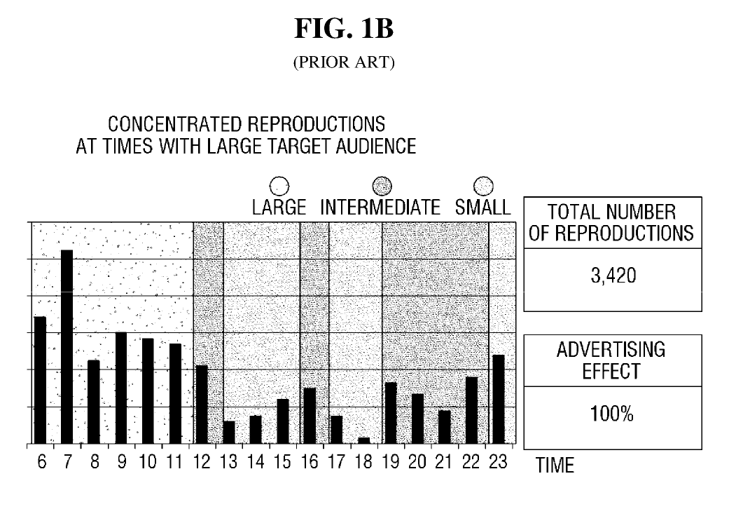

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

The terms used herein are defined as follows.

Scheduling refers to a task of determining the number of times or the order in which scheduling target content is reproduced in each time slot of a scheduling target period.

Content refers to digital information that can be reproduced by an apparatus having a display function. Examples of the content include advertisement content, movie content, and music content.

A scheduling target period refers to the entire period to be scheduled.

Time slots are sections into which a scheduling target period is divided by a time interval of the time slots. The time slots are time units for determining the number of times that scheduling target content is reproduced. For example, if the scheduling target period is ‘1 day’ and the number of times that the scheduling target content is reproduced is determined every ‘1 hour,’ there are a total of 24 time slots (24 hours/1 hour=24), and the number of times that the scheduling target content is reproduced in each time slot is calculated for each content reproducing apparatus as a scheduling result. Also, the time interval of the time slots is ‘1 hour.’

The reproduction time of content (or play time) refers to the running time or playback length of the content.

The total number of reproductions (or total play count) refers to a minimum number of times that scheduling target content should be reproduced by a content reproducing apparatus 300 or 500 during entire scheduling target period or a maximum number of tunes that the scheduling target content can be reproduced by the content reproducing apparatus 300 or 500 during the scheduling target period. For example, in the case of advertisement content, the total number of reproductions may be the minimum number of reproductions determined by an advertisement contract.

A size of the floating population refers to a number of people who visited or pass by a designated geographical location (e.g. near the location where a content reproduction apparatus is installed).

For reference, the terms ‘multiple’ and ‘a plurality of’ may be used interchangeably herein, but have the same meaning. For example, the term “multiple content reproducing apparatuses” has the same meaning as the term “a plurality of content reproducing apparatuses.”

Hereinafter, the inventive concept will e described in detail with reference to the drawings.

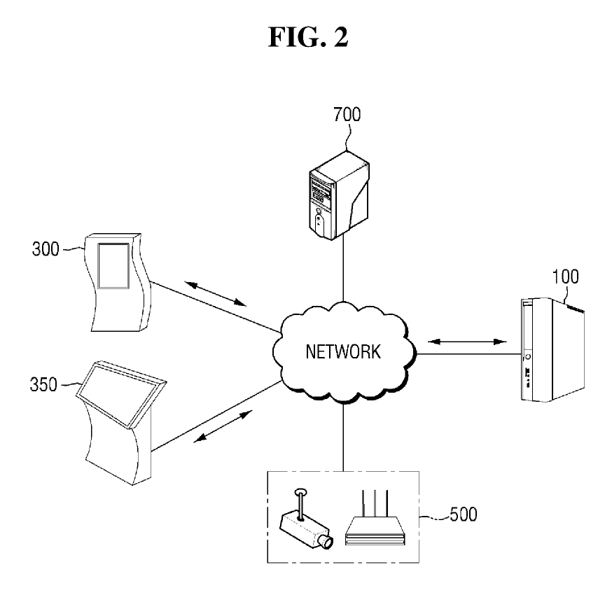

FIG. 2 illustrates the configuration of a content providing system according to an embodiment,

Referring to FIG. 2, the content providing system is a system that produces a scheduling result, which is the number of reproductions of scheduling target content in each time slot for each content reproducing apparatus 300 or 350, and allocates and reproduces the scheduling target content in each time slot of each content reproducing apparatus 300 or 350 based on the scheduling result. For example, the content providing system may be an outdoor advertisement system that reproduces scheduled advertisement content through digital signage.

The content providing system may include a content scheduling apparatus 100, a plurality of content reproducing apparatuses 300 and 350, a data collecting apparatus 500, and a data analyzing apparatus 700. The apparatuses 100, 300, 350, 500 and 700 constituting the content providing system may be connected to each other via a network. Although not illustrated in FIG. 2, the content providing system may further include a content managing apparatus which stores content and a content controlling apparatus which controls the content reproducing apparatuses 300 and 350 according to the scheduling result of the content scheduling apparatus 100.

However, depending on embodiments, the content scheduling apparatus 100 can perform the function of at least one of the content managing apparatus and the content controlling apparatus. Further, depending on embodiments, some of the apparatuses 100, 300, 350, 500 and 700 constituting the content providing system can be omitted.

In FIG. 2, each of the apparatuses 100, 300, 350, 500 and 700 constituting the content providing system is illustrated as a separate physical apparatus. However, depending on embodiments, each of the apparatuses 100, 300, 350, 500 and 700 can also be implemented as a different logic within the same physical apparatus.

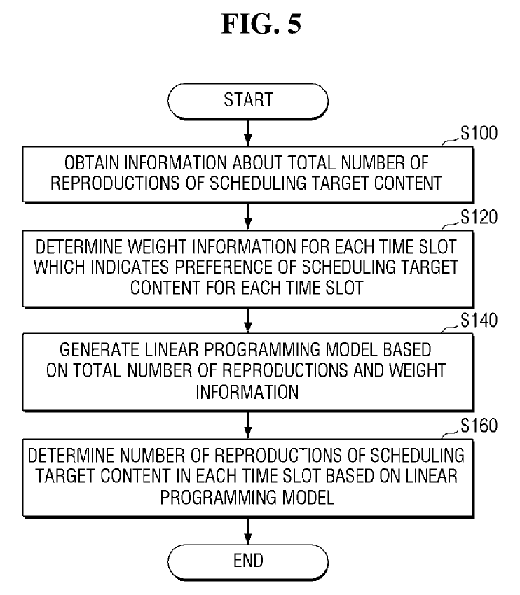

As for each of the apparatuses 100, 300, 350, 500 and 700 constituting the content providing system, the content scheduling apparatus 100 is a computing apparatus that produces a scheduling result of scheduling target content to be reproduced by the content reproducing apparatuses 300 and 350. The content scheduling apparatus 100 may perform content scheduling by considering various preferences for the scheduling target content based on a linear programming model. The various preferences indicate the degree of preference that varies depending on the purpose of scheduling. For example, if the purpose of scheduling is to maximize a content exposure effect, the preference may be determined based on information that can be an indicator of the content exposure effect, such as the number of floating population of a target audience, features of a geographical location where a content reproducing apparatus is installed, and hardware features of the content reproducing apparatus. The preference may be represented in the form a eight. A method by which the content scheduling apparatus 100 determines a preference weight and schedules content will be described in detail later with reference to FIGS. 5 through 13.

For reference, when the content scheduling apparatus 100 also performs the functions of the content managing apparatus and the content controlling apparatus, it may control the content reproduction order or the number of reproductions of the content reproducing apparatuses 300 and 500 through the network based on the scheduling result.

In addition, the computing apparatus may be, but is not limited to, a notebook, a desktop, or a laptop. However, the computing apparatus may be any apparatus having a computing function and a communication function.

Each of the content reproducing apparatuses 300 and 350 is an apparatus that reproduces content according to the scheduling result of the content scheduling apparatus 100. Each of the content reproducing apparatuses 300 and 350 may be implemented in various forms of digital signage such as a kiosk or a video wall installed in a public place such as an airport or a terminal or in a commercial place such as a shopping mall. However, each of the content reproducing apparatuses 300 and 350 is not limited to the above examples and can be implemented as any apparatus having a content reproduction function and a communication function. In the case of a content reproducing apparatus that reproduces music content, a separate display screen may not be provided.

The data collecting apparatus 500 collects raw data such as images of an area around the content reproducing apparatuses 300 and 350 or a place where the content providing system has been built, a WiFi connection history, etc. and transmits the collected raw data to the data analyzing apparatus 700. The data collecting apparatus 500 may include a photographing device such as a camera to collect images and videos and an access point to collect WiFi connection history data. For example, the data collecting apparatus 500 may collect the WiFi connection history data by monitoring the traffic of WiFi probe signals using the access point.

The data analyzing apparatus 700 is an apparatus that analyzes raw data and extracts various information necessary for content scheduling. The data analyzing apparatus 700 may include a video analyzing apparatus for video analytics. The video analyzing apparatus may extract various information necessary for a content algorithm applying at least one computer vision algorithm widely known in the art.

For example, the data analyzing apparatus 700 may extract demographic data such as the number, sex, or age group of floating population at each time of day through video analytics. Then, the data analyzing apparatus 700 may obtain information such as the number of floating population in each time slot and the number of floating population of a target audience of scheduling target content in each time slot based on the extracted demographic data. In addition, the data analyzing apparatus 700 may utilize the number of floating population at each time of day extracted from the WiFi connection history data to more accurately calculate the number of floating population in each time slot.

The data analyzing apparatus 700 may also extract various information such as the waiting time of all customer groups or a target audience at locations where the content reproducing apparatuses 300 and 350 are installed or in a place where the content providing system has been built and staring targets of all customer groups or the target audience passing the content reproducing apparatuses 300 and 350.

The network can be implemented as any type of wired/wireless network such as a local area network (LAN), a wide area network (WAN), or a mobile radio communication network.

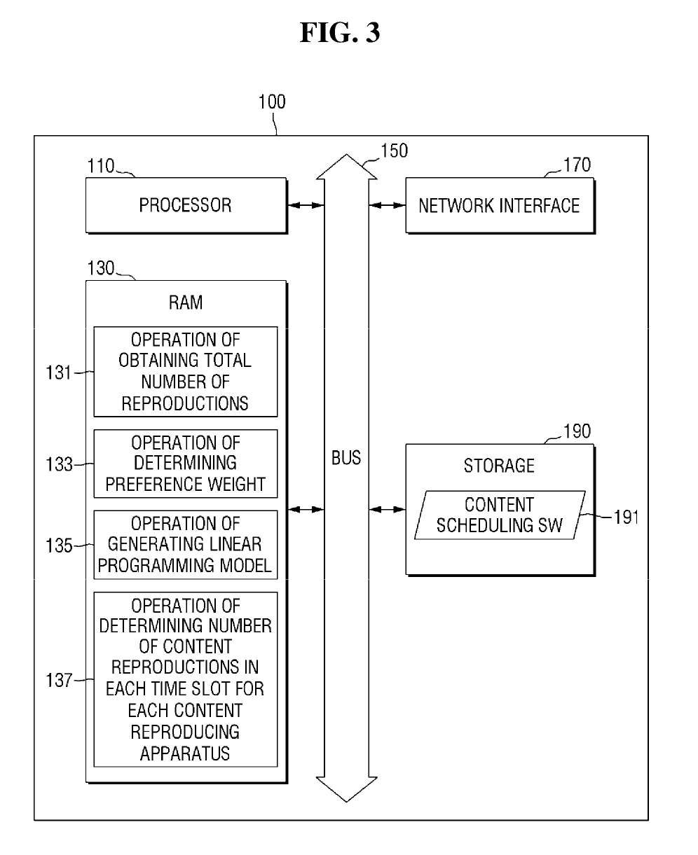

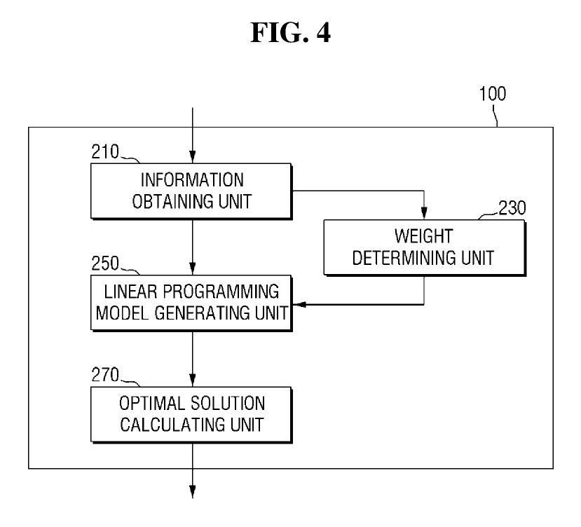

Until now, the content providing system according to the embodiment has been described with reference to FIG. 2. The detailed configuration and operation of the content scheduling apparatus 100 according to an embodiment will now be described with reference to FIGS. 3 and 4.

Referring to FIG. 3, the content scheduling apparatus 100 includes one or more processors 110, a network interface 170, a memory 130 which loads a computer program to be executed by the processors 110, and a storage 190 which stores content scheduling software 191. In FIG. 3, only the components related to the embodiment are illustrated. Therefore, it will be understood by those of ordinary skill in the art to which the inventive concept pertains that other general-purpose components can further be included in addition to the components illustrated in FIG. 3.

The processors 110 control the overall operation of each component of the content scheduling apparatus 100. The processors 110 may include a central processing unit (CPU), a microprocessor unit (MPU), a microcontroller unit (MCU), or any type, of processor well known in the art. In addition, the processors 110 may perform an operation on at least one application or program for performing a method according to embodiments.

The memory 130 stores various data, commands, and/or information. The memory 130 may load one or more programs 191 from the storage 190 to perform a content scheduling method according to embodiments. In FIG. 4, a random access memory (RAM) is illustrated as an example of the memory 130.

The bus 150 provides a communication function between the components of the content scheduling apparatus 100. The bus 150 may be implemented as various types of buses such as an address bus, a data bus, and a control bus.

The network interface 170 supports wired or wireless communication of the content scheduling apparatus 100. To this end, the network interface 170 may include a communication module well known in the art to which the inventive concept pertains.

The network interface 170 may transmit or receive data to or from the content reproducing apparatuses 300 and 350 of FIG. 2 through the network. In addition, the network interface 170 may transmit or receive a control command for content scheduling to or from each of the content reproducing apparatuses 300 and 350.

The storage 190 may non-temporarily store the programs 191. In FIG. 3, content scheduling software 191 is illustrated as an example of the programs 191.

The storage 190 may include a nonvolatile memory such as a read only memory (ROM), an erasable programmable ROM (EPROM), an electrically erasable programmable ROM (EEPROM) or a flash memory, or may include a hard disk, a removable disk, or any type of computer-readable recording medium well known in the art to which the inventive concept pertains.

The content scheduling software 191 may be loaded into the memory 130 and executed by the processors 110 to perform an operation 131 of obtaining the total number of reproductions of scheduling target content,an operation 133 of determining a preference weight which indicates the preference of the scheduling target content for each content reproducing apparatus and has different values for at least some of the content reproducing apparatuses, an operation 135 of generating a linear programming model based on the total number reproductions and the preference weight, and an operation 137 of determining number of reproductions of the scheduling target content in each time slot for each content reproducing apparatus based on the linear programming model.

Referring to FIG. 4, the content scheduling apparatus 100 may include an information obtaining unit 210, a weight determining unit 230, a linear programming model generating unit 250, and an optimal solution calculating unit 270. In FIG. 4, only the components related to the embodiment are illustrated. Therefore, it will be understood by those of ordinary skill in the art to which the inventive concept pertains that other general-purpose components can further e included in addition to the components illustrated in FIG. 4. In addition, each function of the content scheduling apparatus 100 can be performed by the processors 110 of the content scheduling apparatus 100 illustrated in FIG. 3.

As for each component, the information obtaining unit 210 obtains various information needed to generate a linear programming model. For example, the information obtaining unit 210 may obtain various information that the data analyzing apparatus 700 produces by analyzing data such as images and videos. Some of the obtained information may become constraints of the linear programming model or may become basic information used by the weight determining unit 230 to determine a weight.

The types of information obtained by the information obtaining unit 210 include, for example, the total number of reproductions during a scheduling target period, the reproduction time of scheduling target content, the number of floating population in each time slot, the number of floating population of a target audience in each time slot, the preference for each target audience, features of a geographical location where a content reproducing apparatus is installed, and hardware features of the content reproducing apparatus.

The way that the information obtaining unit 210 obtains the above-described information may vary according to the implementation method. For example, the information obtaining unit 210 may receive information directly from a user through a graphical user interface (GUI) or obtain information such as the total number of content reproductions from a pre-stored setting. Alternatively, the information obtaining unit 210 may obtain the above information from data received through the network. That is, the information obtaining unit 210 can obtain information in various ways, which are different only in implementation method.

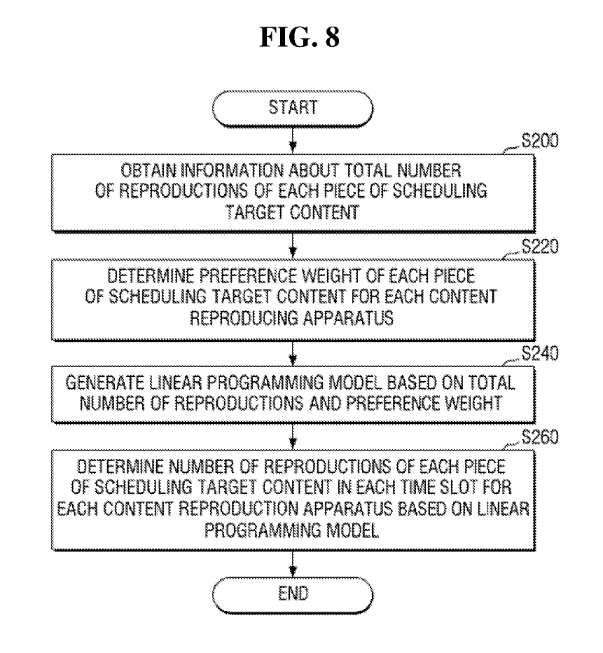

The weight determining unit 230 may determine various weights or priority values, which are coefficients of an objective function of a linear programming model, based on information obtained by the information obtaining unit 210. In detail, the weight determining unit 230 may determine a preference weight indicating the preference of each piece of scheduling target content for each content reproducing apparatus, the priority of each piece of scheduling target content, and a weight (hereinafter, referred to as a “relevance weight”) indicating the relevance of each piece of scheduling target content to nearby store information. A method of determining the preference weight based on the above information will be described later with reference to FIGS. 8 through 13.

The preference weight may indicate the preference for each content reproducing apparatus and each time slot of each content reproducing apparatus. The preference weight may include a first preference weight, a second preference weight and a third preference weight. The first preference weight may indicate a preference weight which has different values for at least some of the content reproducing apparatuses and for at least some of each time slot of the content reproducing apparatuses. The second preference weight may indicate a preference weight which has different values for at least some of the content reproducing apparatuses according to features of geographical locations where the content reproducing apparatuses are installed. The third preference weight may indicate a preference weight which has different values for at least some of the content reproducing apparatuses according to hardware features of the content reproducing apparatuses.

The linear programming model generating unit 250 generates a linear programming model necessary for performing content scheduling in a multi-content reproducing apparatus environment based on information obtained by the information obtaining unit 210 and weight information determined by the weight determining unit 230. Specifically, the linear programming model generating unit 250 sets the number of reproductions of scheduling target content in each time slot for each content reproducing apparatus as a decision variable, sets an objective function by using the weight or priority determined by the weight determining unit 230 and the decision variable, and sets the total number of reproductions of the scheduling target content and the like as constraints. The decision variable, the objective function, and the constraints may vary depending on the purpose of scheduling and the information obtained.

For reference, when the number of reproductions of scheduling target content in each time slot for each content reproducing apparatus is set as a decision variable, the decision variable will be an integer of zero or more. Therefore, the generated linear programming model is an integer linear programming model that calculates an optimal solution or an approximate optimal solution according to an integer linear programing method.

The optimal solution calculating unit 27 (produces a scheduling result by calculating an optimal solution or an approximate optimal solution that satisfies a linear programming model generated by the linear programming model generating unit 250. The optimal solution calculating unit 270 may use one or more algorithms well known in the art in order to obtain the optimal solution or the approximate optimal solution of the linear programming model. For example, the optimal solution calculating unit 270 may use a branch and bound algorithm to calculate the optimal solution. Alternatively, the optimal solution calculating unit 270 may convert the linear programming model into a standard type and then use a simplex algorithm to calculate the approximate optimal solution. The optimal approximate solution can be calculated by converting an approximate solution obtained using the simplex algorithm into an integer through rounding up or down.

In addition, the optimum solution calculating unit 250 may include a software module well known in the art, such as UNDO or LINGO, to perform the branch and bound algorithm or the simplex algorithm described above.

Each component described above with reference to FIG. 4 may be implemented as a software component or a hardware component such as a field programmable gate array (FPGA) or application-specific integrated circuit (ASIC). However, the components are not limited to the software or hardware components and may be configured to reside on the addressable storage medium and configured to execute one or more processors. The functionality provided for in the components may be further separated into additional components or combined into fewer components.

Until now, the content scheduling apparatus 100 according to the embodiment has been described with reference to FIGS. 3 and 4. A content scheduling method according to an embodiment will hereinafter be described.

The content scheduling apparatus 100 can perform content scheduling for a single content reproducing apparatus or multiple content reproducing apparatuses 300 and 350 based on a linear programming model. In order to facilitate understanding, a content scheduling method performed by the content scheduling apparatus 100 in a single content reproducing apparatus environment will first be described with reference to FIGS. 5 through 7.

FIG. 5 is a flowchart illustrating a content scheduling method performed in a single content reproducing apparatus environment. It should be noted that the subject of each operation included in the content scheduling method can be omitted for ease of understanding.

Referring to FIG. 5, the content scheduling apparatus 100 obtains the total number of reproductions of each piece of scheduling target content (operation S100). As described above, the total number of reproductions refers to the minimum number of times that each piece of scheduling target content should be reproduced during a scheduling target period or the maximum number of times that each piece of scheduling target content can be reproduced during the scheduling target period. The total number of reproductions may be the number of reproductions determined by, e.g., a contract between a content providing entity and a content reproducing entity.

Next, the content scheduling apparatus 100 determines a weight for each time slot which indicates the preference of each piece of scheduling target content for each time slot (operation S120). For example, when the time interval of the time slots is ‘1 hour,’ the content scheduling apparatus 100 determines the weight for each time slot in units of one hour. The weight for each time slot is a value set as a coefficient of an objective function of a linear programming model generated by the content scheduling apparatus 100. The weight for each time slot may be determined based on various information according to the purpose of scheduling.

For example, when scheduling is performed for the purpose of maximizing the effect of content exposure to a target audience, the content scheduling apparatus 100 may determine the weight value for each time slot based on the number of floating population of the target audience in each time slot. For example, if the target audience of scheduling target content is ‘men in their twenties,’ the content scheduling apparatus 100 may determine the weight for each time slot based on the number of floating population of ‘men in their twenties’ in each time slot. That is, the content scheduling apparatus 100 may determine the weight for each time slot by giving a greater weight value to a time slot corresponding to a time when the floating population of the target audience is large.

In another example, when scheduling is performed for the purpose of providing the scheduling target content at a time when the floating population is large regardless of the target audience of the scheduling target content, the content scheduling apparatus 100 may determine the weight for each time slot based on the number of floating population in each time slot.

In another example, when scheduling is performed for the purpose of maximizing the effect of content exposure to the target audience against the content contract cost, the content scheduling apparatus 100 may determine the weight for each time slot based on a value obtained by dividing the number of floating population of the target audience in each time slot by the content contract cost.

As described above, information such as the number of floating population in each time slot and the number of floating population of a target audience in each time slot may be produced by the data analyzing apparatus 700 through video analytics using a computer vision algorithm. In addition, the data analyzing apparatus 700 may further utilize WiFi data collected through an access point in order to more accurately calculate the number of floating population in each time slot.

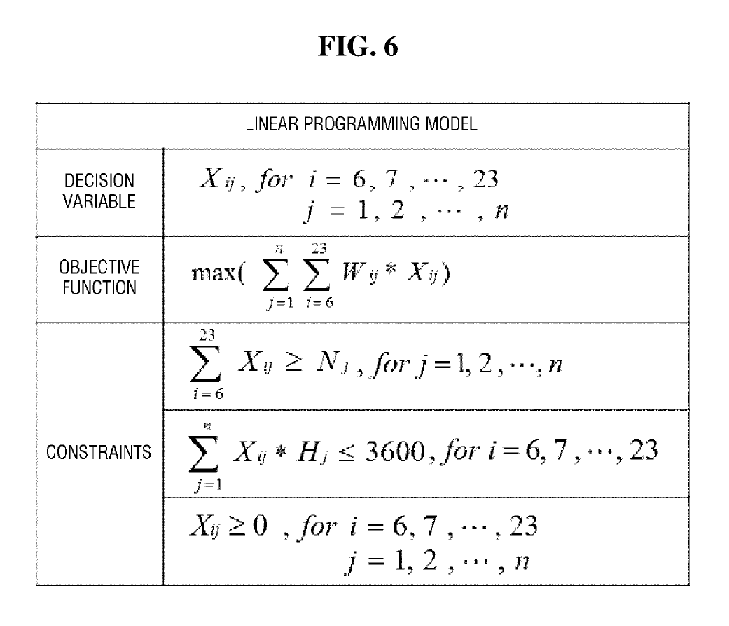

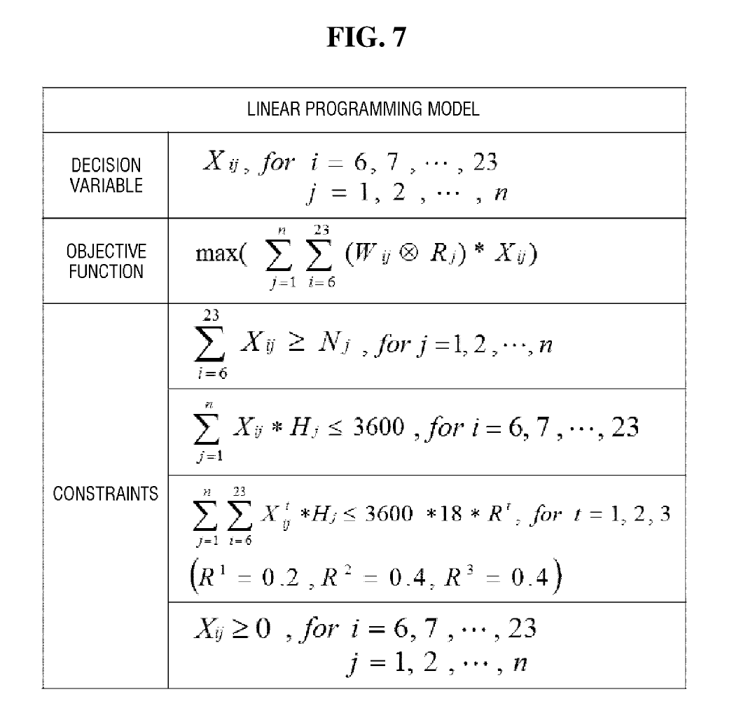

Next, the content scheduling apparatus 100 generates a linear programming model using the total number of reproductions and the weight for each time slot (operation S140). In detail, the content scheduling apparatus 100 sets the number of reproductions of each piece of scheduling target content in each time slot as a decision variable, sets an objective function by using the weight of each piece of scheduling target content for each time slot and the decision variable, and sets constraints by using the total number of reproductions and the decision variable. The linear programming model may vary depending on the purpose of scheduling or the information obtained. The linear programming model will be described in detail later with reference to FIGS. 6 and 7.

After generating the linear programming model, the content scheduling apparatus 100 determines the number of reproductions of each piece of scheduling target content in each time slot based on the linear programming model (operation S160). In other words, the content scheduling apparatus 100 may determine the number of reproductions of each piece of scheduling target content in each time slot by calculating the value of the decision variable corresponding to an optimal solution or approximate optimal solution of the linear programming model. The optimal solution or optimal approximate solution of the linear programming model can be calculated using the branch and bound algorithm or the simplex algorithm as described above.

Until now, the content scheduling method that can be performed in the single content reproducing apparatus environment has been described. According to the above-described embodiment, the content scheduling apparatus 100 can perform scheduling in consideration of the weight for each time slot which indicates the preference for each time slot. In addition, since the weight for each time slot is determined according to the purpose of scheduling, various purpose-based scheduling can be performed. Furthermore, since the weight for each time slot is determined based on the number of floating population of a target audience of scheduling target content in each time slot and scheduling is performed based on the determined weight, the effect of content exposure to the target audience can be improved.

Next, linear programming models that the content scheduling apparatus 100 can generate to perform scheduling for a single content reproducing apparatus will be described with reference to FIGS. 6 and 7. It will be assumed that the number of pieces of scheduling target content is ‘n’, a scheduling target period is ‘1 day,’ and a time interval of time slots is ‘1 hour,’ unless otherwise stated. However, this assumption is only for ease of description, and the number of pieces of scheduling target content, the scheduling target period and the time interval of the time slots can be changed as desired.

FIG. 6 illustrates a linear programming model that can perform scheduling in consideration of a weight, for each time slot which indicates the preference of scheduling target content for each time slot.

Referring to FIG. 6, a decision variable Xij indicates the number of times that a ‘j^{th}’ of scheduling target content among the ‘n’ pieces of scheduling target content is reproduced in an ‘i^{th}’ time slot. For example, a decision variable X15 indicates the number of times that a fifth piece of scheduling target content is reproduced in a first time slot. Since the number of time slots is 24 (24 hours/1 hour=24) according to the above assumption, a variable i may be an integer of 1 to 24, and a variable j may be an integer of 1 to n. Accordingly, the number of decision variables Xij is ‘24n.’

Next, an objective function of the linear programming model illustrated in FIG. 6 may be set as a function that maximizes the sum of values obtained by multiplying the decision variable Xij by a weight Wij for each time slot which indicates the preference for each time slot. This is because the value of the objective function becomes larger as scheduling target content is allocated to a more preferred time slot.

The weight Wij for each time slot is a weight value that the ‘j^{th}’ piece of scheduling target content among the ‘n’ pieces of scheduling target content has in the ‘i^{th}’ time slot. The weight Wij for each time slot may be set to a larger value as the preference of scheduling target content for each time slot is higher.

According to duality of a linear programming model, the objective function can also be determined as a function that minimizes the sum of values obtained by multiplying the decision variable Xij by a weight determined using another method. However, it should be noted that this is only a modification made according to the duality of the linear programming model and is substantially the same model as the linear programming model illustrated in FIG. 6. The duality of the linear programming model is a well-known concept in the technical field of the inventive concept. Thus, a detailed description of the duality of the linear programming model will be omitted because it can obscure the point of the inventive concept. Objective functions and constraints of linear programming models to be described later can also vary according to the duality. However, this may only be a difference in representation of a linear programming model as described above.

Lastly, constraints are as follows. The content scheduling apparatus 100 may set any one of a first constraint (ΣXij≤Nj) that the sum ΣXij of decision variable values of each piece of scheduling target content is larger than or equal to the total number of reproductions Nj of the corresponding piece of scheduling target content and a second constraint (ΣXij≤Nj) that the sum ΣXij of the decision variable values of each piece of scheduling target content is smaller than or equal to the total number of reproductions Nj of the corresponding piece of scheduling target content as a constraint of the linear programming model.

Specifically, the content scheduling apparatus 100 may set the first constraint when the total number of reproductions denotes the minimum number of reproductions during the scheduling target period and set the second constraint when the total number of reproductions denotes the maximum number of reproductions during the scheduling target period. For example, when the total number of reproductions is given by a content contract, the content scheduling apparatus 100 may set the first constraint as a constraint of the linear programming model because the total number of reproductions specified in the contact he minimum number of reproductions that should be performed during the target scheduling period. In the linear programming model of FIG. 6, the total number of reproductions is the minimum number of reproductions.

Since the constraint regarding the total number of reproductions can be set for each piece of scheduling target content, ‘n’ constraints (ΣXij≤Nj, j=1, 2, . . . , n) may be set as constraints regarding the total number of reproductions in the linear programming model of FIG. 6.

Next, the content scheduling apparatus 100 may set a constraint (ΣXij*Hj≤3600) that the sum (ΣXij*Hj) of values obtained by multiplying a decision variable value of scheduling target content in each time slot by a reproduction time Hj of the scheduling target content is smaller than the time interval (‘3600’) of the time slots as an additional constraint of the linear programming model. This is because the number of reproductions in each time slot, which is the value of the decision variable Xij, should be determined as the number of reproductions that can be performed within the time range of the corresponding time slot. Since the additional constraint can be set for each time slot, a total of ‘24’ constraints (ΣXij*Hj≤3600, i=1, 2, . . . , 24) may be set.

For reference, the time interval (‘3600’) of the time slots in the linear programming model of FIG. 6 is a value obtained by converting the time interval of the time slots assumed to be 1 hour into seconds (1 hour*60 minutes*60 seconds=3600). This reflects the fact that the reproduction time Hj of content is generally determined in units of seconds.

The final constraint is a non-negative constraint (Xij≤0) on the decision variable Xij. This reflects the fact that the decision variable Xij, which is the number of content reproductions in each time slot, is always greater than or equal to zero. Since the non-negative constraint is set for all decision variables, a total of ‘24n’ constraints may be set.

After generating the linear programming model, the content scheduling apparatus 100 may determine the number of reproductions of each piece of scheduling target content in each time slot by calculating an optimal solution or an approximate optimal solution, which is the value of the decision variable Xij that maximizes the objective function of FIG. 6, based on feasible solutions satisfying the constraints illustrated in FIG. 6.

A linear programming model generated by the content scheduling apparatus 100 for a single content reproducing apparatus when conditions regarding the operation time of the content reproducing apparatus, the reproduction proportion of each type of scheduling target content, and the priority of scheduling target content are added will now he described with reference to FIG. 7.

As for each condition, the operation time refers to a total period of time during which a content reproducing apparatus 300 or 350 is operated. In an actual example, an accessible time of a place where the content reproducing apparatus 300 or 350 is installed may be fixed, or the operation time of the content reproducing apparatus may be restricted according to an operating policy of the content reproducing apparatus.

The priority of scheduling target content may be a priority that the content scheduling apparatus 100 determines by reflecting a contract cost between a content providing entity and a content reproducing entity. For example, in the case of advertisement content, the content scheduling apparatus 100 may give a higher priority to scheduling target content with a high advertising cost. That is, the priority of scheduling target content determined by the content scheduling apparatus 100 may be information used to prioritize a plurality of pieces of scheduling target content having the same weight for each time slot. Alternatively, the priority of the scheduling target content determined by the content scheduling apparatus 100 may be information used to preferentially allocate a specific piece of scheduling target content even if the weight of the specific piece of scheduling target content for each time slot is low.

The reproduction proportion of each type of scheduling target content denotes a condition that, for example, public service content should be reproduced in a specific proportion or more. In an actual example, the above condition may be added according to legal regulations or the operating policy of the content reproducing apparatus 300 or 350. For example, the “Enforcement Decree of the Act on the Management of Outdoor Advertisements, etc. and Promotion of Outdoor Advertisement industry” stipulates that the contents of an advertisement for public purposes should be reproduced within the scope of 20/100 of an hour.

The content scheduling apparatus 100 may generate a linear programming model illustrated in FIG. 7 by reflecting the above-described conditions. First, since the scheduling target period is changed due to the constraint of the operation time, the content scheduling apparatus 100 may change the number of the decision variables Xij according to the changed scheduling target period. For example, when the content scheduling apparatus 100 obtains information that the operation time of the content reproducing apparatus 300 or 350 is ‘18 hours (6:00 to 23:00),’ it may change the scheduling target period to 18 hours. In addition, since the number of time slots is changed to ‘1.8’ according to the changed scheduling target period, the content scheduling apparatus 100 may adjust the number of the decision variables Xij by adjusting the range of values of the variable i of the decision variable Xij to an integer range of 6 to 23.

Next, the content scheduling apparatus 100 may reflect priority information of scheduling target content in an objective function of the linear programming model. This is intended to preferentially allocate a specific piece of scheduling target content having a high priority value even if the specific piece of scheduling target content has a smaller weight for each time slot than other pieces of scheduling target content.

Referring to the objective function of the linear programming model of FIG. 7, an operator (\textcircled{x}) is an arbitrary operator. The content scheduling apparatus 100 may determine the operator in consideration of the relationship between the weight Wij of scheduling target content for each time slot and a priority Rj of the scheduling target content. In addition, an operator derived based on the result of experiments on various operators can be set in advance.

For example, the operator may be set to a ‘multiplication operator.’ That is, the content scheduling apparatus 100 may set a function, which maximizes the sum of values obtained by multiplying the weight Wij of scheduling target content for each time slot, the priority Rj of the scheduling target content, and the decision variable Xij, as an objective function. When this objective function i used, scheduling target content can be scheduled to be placed in a corresponding time slot if any one of the value of the weight Wij for each time slot and the value of the priority Rj of the scheduling target content is large.

For reference, the priority of scheduling target content in the linear programming model of FIG. 7 is indicated by ‘Rj’ based on the assumption that it varies according to scheduling target content but not according to time slot. However, if the priority information of scheduling target content varies according to time slot, the priority of the scheduling target content in the linear programming model may be changed to ‘Rij.’

Reflecting the priority of scheduling target content in the objective function separately from the weight for each time slot can bring about he following advantage. For example, if the priority has been determined based on the content contract cost, scheduling is performed in consideration of not only the weight of scheduling target content for each time slot but also the content contract cost. Therefore, the profit of a content reproducing entity can be improved. That is, of a plurality of pieces of scheduling target content having similar weights for each time slot, a more costly piece of scheduling target content is allocated preferentially. Accordingly, this can increase the content contract cost through competition, thereby improving the profit of the content reproducing entity.

Lastly, the reproduction proportion of each content type may be reflected in constraints of the linear programming model. The reason why the reproduction proportion information is added to the constraints is that the total scheduling time of scheduling target content is reduced if the content reproduction proportion is added. For example, if content for public interest is added in a proportion of 20/100 per hour, the scheduling target content can be scheduled within 48 minutes (60 minutes*80/100=48) per hour. Therefore, the content reproduction proportion is set as a constraint.

The content scheduling apparatus 100 can generate a new linear programming model by adding a constraint that the total reproduction time of each content type is smaller than or equal to a value obtained by multiplying the reproduction proportion of each content type by the scheduling target period. When a constraint on the operation time of the content reproducing apparatus 300 is added as described above, the scheduling target period is the operation time of the content reproducing apparatus 300.

The linear programming model illustrated in FIG. 7 is a linear programming model generated when the operation time of the content reproducing apparatus 300 is ‘18 hours’ and when the proportions of a public service advertisement, an shopping mall related advertisement and an external advertisement are 20%, 40% and 40%, respectively. A variable t indicates a content type. That is, the variable t indicates the public service advertisement when having a value of ‘1,’ indicates the shopping mall related advertisement when having a value of ‘2,’ and indicates the external advertisement when having a value of ‘3.’ In addition, an expression (ΣΣXtij*Hj) indicates the total reproduction time of each content type, and a variable R^{t} indicates the reproduction proportion of each content type.

Referring to FIG. 7, a content reproduction proportion R¹ of the public service advertisement is 0.2, a content reproduction proportion R² of the shopping mall related advertisement is 0.4, and the content reproduction proportion R³ of the external advertisement is ‘0.4’ according to the above-described proportions. In addition, since the scheduling target period is 18 hours, it can be converted into ‘3600*18’ seconds.

When scheduling target content is the external advertisement content (t=3), the content scheduling apparatus 100 may produce a scheduling result by calculating an optimal solution or an approximate optimal solution of the linear programming model that additionally includes a constraint (ΣΣX3jj*Hj≤3600*18*R³) regarding the content reproduction proportion R³. In addition, when the scheduling target content is the public service advertisement content (t=1), the content scheduling apparatus 100 may produce a scheduling result by calculating an optimal solution or an approximate optimal solution of the linear programming model that additionally includes a constraint (ΣΣX1ij*Hj≤3600*18*R¹) regarding the content reproduction proportion R¹.

Until now, the content scheduling method that can be performed in the single content reproducing apparatus environment and the linear programming models for performing the content scheduling method have been described. The above-described inventive concept will be expanded to describe a content scheduling method that can be performed in a multi-content reproducing apparatus environment and linear scheduling models for performing the content scheduling method.

FIG. 8 is a flowchart illustrating a scheduling method that can be performed in a multi-content reproducing apparatus environment. It will hereinafter be assumed that a plurality of content reproducing apparatuses are installed at different geographical locations. However, it should be noted that the inventive concept can be equally applied to a case where the content reproducing apparatuses are installed at the same or adjacent locations.

Referring to FIG. 8, the content scheduling apparatus 100 obtains the total number of reproductions of each piece of scheduling target content (operation S200). The total number of reproductions of each piece of scheduling target content is not the number of times that each piece of scheduling target content is reproduced by each content reproducing apparatus, but is the sum of the numbers of times that each piece of scheduling target content is reproduced by the content reproducing apparatuses. For example, when the content providing system includes tour content reproducing apparatuses, the total number of reproductions of each piece of scheduling target content is the total number of times that each piece of scheduling target content is reproduced by the four content reproducing apparatuses. In some cases, the total number of reproductions may be the minimum number of times that each piece of scheduling target content should be reproduced during a scheduling target period or the maximum number of times that each piece of scheduling target content can be reproduced during the scheduling target period.

Next, the content scheduling apparatus 100 determines a preference weight, which is a coefficient of an objective function of a linear programming model, in order to generate a linear programming model for a plurality of content reproducing apparatuses (operation S220). The preference weight is a value indicating the preference of each piece of scheduling target content for each content reproducing apparatus.

The preference weight may include a first preference which has different values for at least some of the content reproducing apparatuses and for at least some of each time slot of the content reproducing apparatuses, a second preference weight which has different values for at least some of the content reproducing apparatuses according to features of geographical locations where the content reproducing apparatuses are installed, and a third preference weight which has different values for at least some of the content reproducing apparatuses according to hardware features of the content reproducing apparatuses.

The weight for each time slot used in content scheduling performed in the single content reproducing apparatus environment can he considered as a weight that reflects only the preference of scheduling target content for each time.

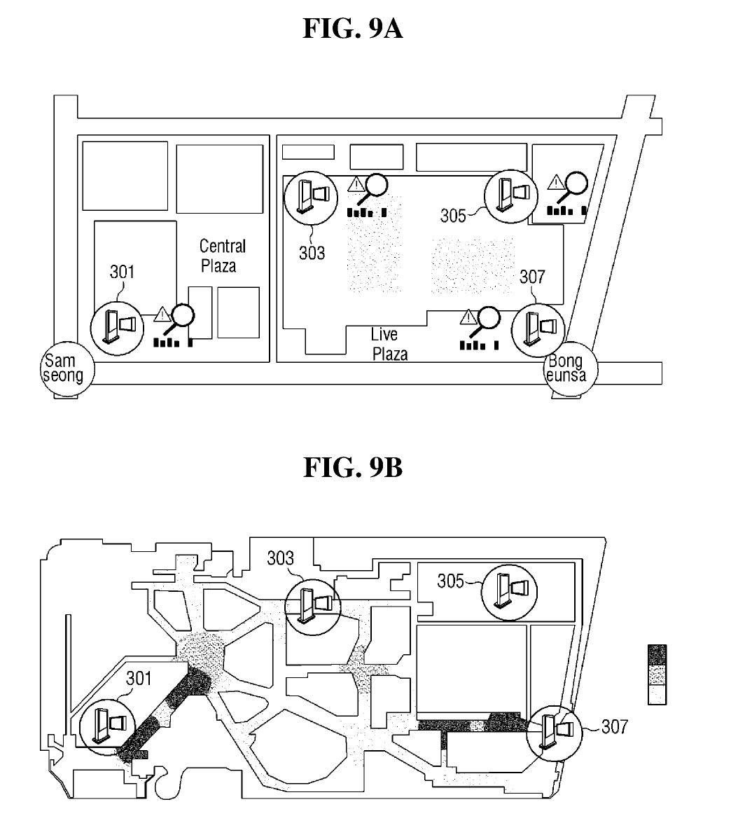

On the other hand, the first preference weight is a weight expanded from the weight for a single content reproducing apparatus in each time slot by reflecting the preference for each content reproducing apparatus in the weight for the single content reproducing apparatus in each time slot. For example, the number of floating population in each time slot or the number of floating population of a target audience of scheduling target content in each time slot may vary according to the installation location of each content reproducing apparatus. Therefore, the scheduling target content that prefers a location having a large floating population may also have a different preference for each content reproducing apparatus. The first preference weight can be understood as a weight that reflects this point. A method by which the content scheduling apparatus 100 determines the first preference weight based on the number of floating population of the target audience of the scheduling target content in each time slot will be described later with reference to FIGS. 9A and 9B.

In addition, the second preference weight is a preference that can vary according to features of a geographical location where each content reproducing apparatus is installed. Here, the features of the geographical location are features irrelevant to a change in the number of floating population at the geographical location where each content reproducing apparatus is installed. For example, the features of the geographic location may include an entrance, an exit, crossroads, and an area around an elevator. This reflects the fact that a content reproducing apparatus installed at a location having the above features is more likely to be used by certain customers.

In addition, the third preference weight is a weight that reflects hardware features that may be different for each content reproducing apparatus. The hardware features are features irrelevant to a geographical location where each content reproducing apparatus is installed and a change in the number of floating population at the geographical location. The hardware features may include, for example, the type of a display, the size of the display, the resolution of the display, and whether sound can be reproduced. The third preference weight reflects the fact that the larger the display or the higher the resolution of the display, the better the content exposure effect.

As described above, while scheduling is performed using only the weight of scheduling target content for each time in the single content reproducing apparatus environment, it may be performed in consideration of additional preferences, which may be different for each content reproducing apparatus, in the multi-content reproducing apparatus environment.

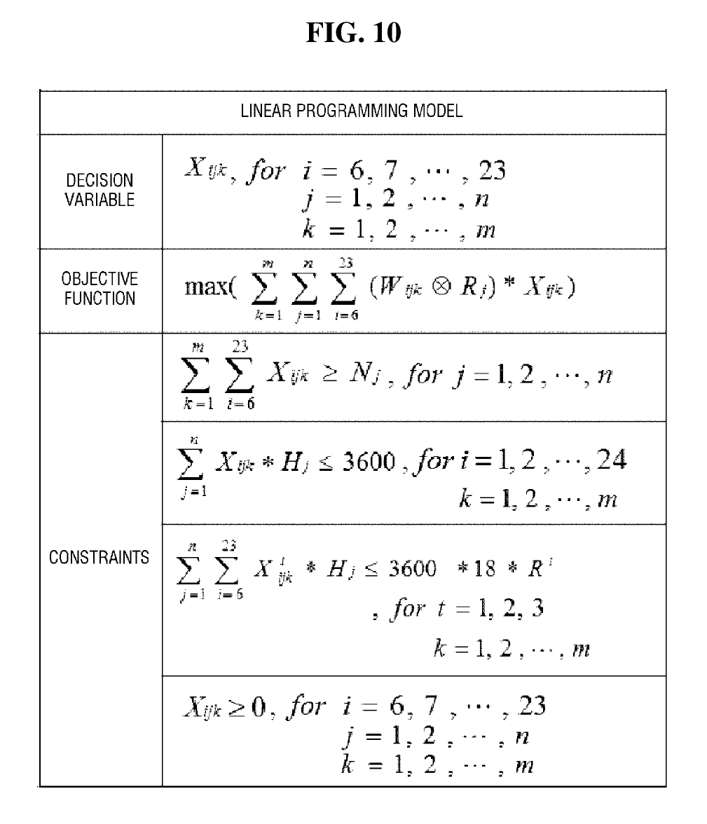

Next, the content scheduling apparatus 100 generates a linear programming model of the multi-content reproducing apparatus environment based on the total number of reproductions and the preference weight (operation S240). In detail, the content scheduling apparatus 100 sets the number of reproductions of each piece of scheduling target content in each time slot for each content reproducing apparatus as a decision variable, sets an objective function by using the preference weight and the decision variable, and sets constraints by using the total number of reproductions and the decision variable. Here, the preference weight used in the objective function may include at least one of the first preference weight, the second preference weight, and the third preference weight described above. However, the linear programming model generated by the content scheduling apparatus 100 may vary depending on the purpose of scheduling or information obtained. The linear programming model will be described in detail later with reference to FIGS. 10, 11 and 13.

After generating the linear programming model, the content scheduling apparatus 100 determines the number of reproductions of each piece of scheduling target content in each time slant for each content reproducing apparatus by calculating an optimal solution or an approximate optimal solution based on the linear programming model (operation S260). The optimal solution or approximate optimal solution of the linear programming model may be calculated in the same way as that of the linear programming model in the single content reproducing apparatus environment.

Until now, the content scheduling method that can be performed in the multi-content reproducing apparatus environment has been described with reference to FIG. 8. According to the above-described inventive concept, the content scheduling apparatus 100 can perform optimal content scheduling even in the multi-content reproducing apparatus environment by using various preference weights that can be derived as the environment changes from the single content reproducing apparatus environment to the multi-content reproducing apparatus environment.

Next, a method by which the content scheduling apparatus 100 determines the first preference weight based on the number of floating population of a target audience of scheduling target content in each time slot will be described. For ease of understanding, a content providing system illustrated in FIG. 9A will be described as an example.

Referring to FIG. 9A, the content providing system illustrated in FIG. 9A includes four content reproducing apparatuses 301, 303, 305 and 307 located in a shopping mall, and the content reproducing apparatuses 301, 303, 305 and 307 are installed at different geographical locations. The content reproducing apparatuses 301, 303, 305 and 307 may be implemented, for example, as digital signage and may provide advertisement content or various information to people using the shopping mall.

The content providing system illustrated in FIG. 9A does not include a content scheduling apparatus 100, a data collecting apparatus 500, a data analyzing apparatus 700, and a network. However, this is merely for ease of description, and the content providing system of FIG. 9A can include the content scheduling apparatus 100, the data collecting apparatus 500, and the data analyzing apparatus 700.

If the purpose of scheduling is to a maximize the effect of content exposure to a target audience, the content scheduling apparatus 100 may determine a weight value for each time slot based on the number of floating population of the target audience in each time slot. For example, the content scheduling apparatus 100 may determine the first preference weight by giving a larger weight to a time slot corresponding to a time when the number of floating population of the target audience is large.

In order to reflect the fact that the number of floating population varies according to a geographical location where each content reproducing apparatus 301, 303, 305 or 307 is installed, the content scheduling apparatus 100 may use a heat map, which is information generated through video analytics, as illustrated in FIG. 9B. The heat map shows information about the number of floating population of the target audience on a digital map. In FIG. 9B, a darker area indicates a larger floating population.

Referring to FIG. 9B, the content scheduling apparatus 100 may divide the shopping mall where the content reproducing apparatuses 301, 303, 305 and 307 are installed into a plurality of areas based on the number of floating population of the target audience. In FIG. 9B, the shopping mall is divided into three areas. Each area has a similar number of floating population of the target audience and is shaded in the same gray level in the heat map. The location and size of each area can be changed dynamically according to a change in the number of floating population of the target audience.

The content scheduling apparatus 100 may give a preset weight to each of the three areas. For example, a highest weight may be set for a first area shaded darkest, a second highest weight may be set for a second area shaded intermediate, and a lowest weight may be set for a third area shaded lightest.

Next, the content scheduling apparatus 100 may determine a weight for an area, which corresponds to a geographical location where each content reproducing apparatus 301, 303, 305 or 307 is installed, as the first preference weight. For example, the content scheduling apparatus 100 may determine the weight given to the first area shaded darkest as the first preference weight for the content reproducing apparatus 301 located in the first area. In addition, the content scheduling apparatus 100 may determine the weight given to the second area shaded intermediate as the first preference weight for the content reproducing apparatus 303 located in the second area. Therefore, when a plurality of content reproducing apparatuses are located in the same area, the content scheduling apparatus 100 may determine the same value as the first preference weight for the content reproducing apparatuses. For example, the content scheduling apparatus 100 may determine the weight value given to the first area as the first preference weight for the content reproducing apparatuses 301 and 307 located in the first area.

The content scheduling apparatus 100 determines a weight for an area, where each content reproducing apparatus 301, 303, 305 or 307 is located, in each time slot as the first preference weight. Therefore, the first preference weight can be determined based on the number of floating population of the target audience of the scheduling target content in each time slot.

In order to more accurately determine the first preference weight determined based on the number of floating population of the target audience in each time slot, the content scheduling apparatus 100 may correct the first preference weight based on at least one of a waiting time of the target audience of the scheduling target content and a staring target of the target audience. This is because the effect of content exposure to the target audience is greater when the waiting time of the target audience in a preset range from a geographical location where a content reproducing apparatus is installed is longer and when the staring target of the target audience is the content reproducing apparatus.

For example, even if the floating population of the target audience is large, when the waiting time of the target audience is short, the effect of content exposure to the target audience may not be great. In this case, the content scheduling apparatus 100 may correct the first preference weight to a smaller value. Conversely, when the waiting time of the target audience is long, the content scheduling apparatus 100 may correct the first preference weight to a larger value.

The waiting time of the target audience and the staring target of the target audience may be extracted by the data analyzing apparatus 700. Specifically, the content analyzing apparatus 700 may extract the waiting time of the target audience and the staring target of the target audience by analyzing videos collected within a preset range from the geographical location of each content reproducing apparatus 301, 303, 305 or 307 by applying a computer vision algorithm.

For reference, the first preference weight can be determined in the same way as described above even when the scheduling target content is to be provided at a time when there is a large floating population regardless of the target audience of the scheduling target content. At this time, a heat map for the entire floating population may be used.

Next, a linear programming model that produces a scheduling result using the first preference weight in the multi-content reproducing apparatus environment will be described with reference to FIG. 10.

FIG. 10 illustrates a linear programming model expanded from the linear programming model of FIG. 7 to apply the linear programming model of FIG. 7 to the multi-content reproducing apparatus environment. In linear programming models to be described below, it will be assumed that there are ‘m’ content reproducing apparatuses. In addition, it will be assumed that the number of pieces of scheduling target content, a scheduling target period, and the time interval of time slots are the same as those in the linear programming model of FIG. 7.

Referring to FIG. 10, a decision variable Xijk indicates the number of times that a ‘j^{th}’ piece of scheduling target content is reproduced in an ‘i^{th}’ time slot of a ‘k^{th}’ content reproducing apparatus. For example, a decision variable X154 indicates the number of times that a fifth piece of scheduling target content is reproduced in a first time slot of a fourth content reproducing apparatus. Since the number of time slots is 18 (18 hours/1 hour=18) according to the above assumptions, a variable i may be an integer of 6 to 23, a variable j may be an integer of 1 to n, and a variable k may be an integer of 1 to in. Accordingly, the number of decision variables Xijk is ‘24 mn.’

Referring to an objective function, a first preference weight Wijk denotes a preference weight that the ‘j^{th}’ piece of scheduling target can have for the ‘k^{th}’ content reproducing apparatus in the ‘i^{th}’ time slot.

An operator (\textcircled{x}) is an arbitrary operator. The content scheduling apparatus 100 may determine the operator in consideration of the relationship between the first preference weight Wijk and a priority Rj of scheduling target content.

For example, the content scheduling apparatus 100 may determine the operator to be a ‘multiplication operator,’ That is, the content scheduling apparatus 100 may set a function, which maximizes the sum of values obtained by multiplying the first preference weight Wij, the priority Rj of scheduling target content, and the decision variable Xijk, as an objective function. This is because scheduling target content can be scheduled to be placed in a corresponding time slot if any one of the value of the first preference weight Wijk and the value of the priority Rj of the scheduling target content is large.

Lastly, details about constraints can be found in the above description of the linear programming model illustrated in FIG. 7.

The content scheduling apparatus 100 can perform scheduling for multiple content reproducing apparatuses by calculating an optimal solution or an approximate optimal solution of the linear programming model illustrated in FIG. 10.

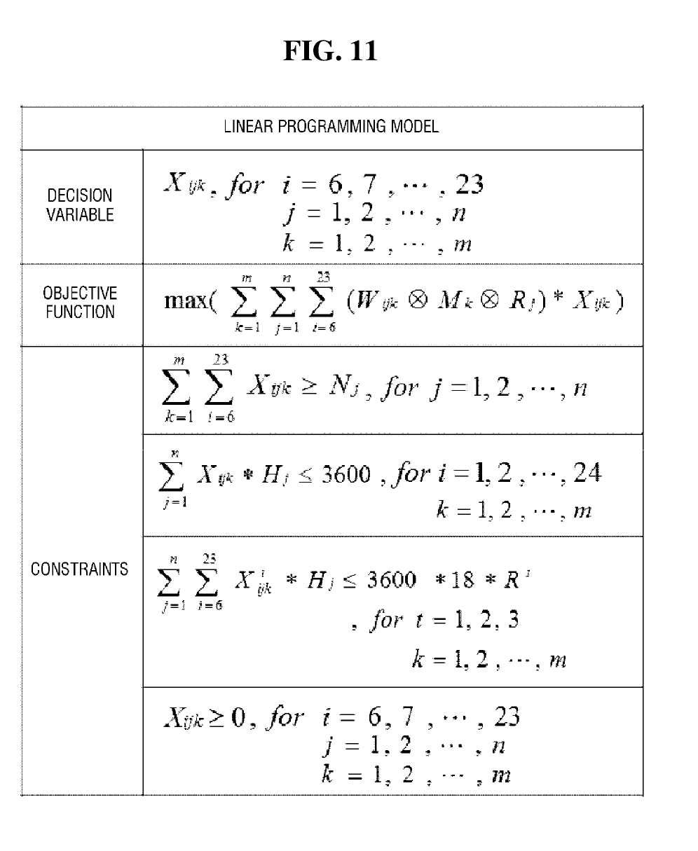

Until now, the linear programming model generated using the first preference weight has been described. Next, a linear programming model generated by the content scheduling apparatus 100 after determining the second preference weight according to the location of each content reproducing apparatus will be described with reference to FIG. 11.

In order to more accurately calculate a preference weight used in the linear programming model, the content scheduling apparatus 100 may determine the second preference weight, which is a preference weight that can vary according to locational features of a content reproducing apparatus, and reflect the second preference weight in the linear programming model.

The content scheduling apparatus 100 may determine whether a geographical location, where each content reproducing apparatus is installed, in a place where the content providing system has been built has preset geographical features and may determine the second preference weight based on the determination result. The preset geographical features may include an entrance, an exit, crossroads, etc., as described above.

Referring back to FIG. 9B, the content reproducing apparatuses 301 and 307 are located at exits or entrances of the shopping mall where the content providing system has been built. At the exits or the entrances, customers visiting the shopping mall are more likely to utilize the content reproducing apparatuses 301 and 307 in order to use a service such as route search. In addition, when the content reproducing apparatus 303 is installed at a crossroads, the visiting customers may usually use the content reproducing apparatus 303 because the customers have to select one route. Therefore, when a geographical location where a content reproducing apparatus is installed has the preset geographical features, the content scheduling apparatus 100 may determine a relatively large value as the second preference weight for the content reproducing apparatus.

For reference, information about whether the location of each content reproducing apparatus serves as an entrance, an exit, a crossroads, etc. is not manually input. Instead, each content reproducing apparatus is equipped with an indoor positioning system (IPS), and the location of each content reproducing apparatus is analyzed on a digital map. Therefore, features of the geographical location where each content reproducing apparatus is installed can be automatically extracted.

Considering that the content exposure effect depends more on those who are actually exposed to content among the floating population of a target audience, the accuracy of the preference weight used in the linear programming model can be improved by using the second preference weight that can be given according to features of a geographical location.

Next, a linear programming model that reflects the second preference weight will be described with reference to FIG. 11. A decision variable and constraints of the linear programming model of FIG. 11 are the same as those of the linear programming model illustrated in FIG, 10. Therefore, the description of FIG, 10 can be referred to for details about the decision variable and the constraints.

Referring to an objective function of the linear programming model illustrated in FIG. 11, a second preference weight Mk denotes a preference weight for a ‘k^{th}’ content reproducing apparatus according to the geographical location of the content reproducing apparatus. The second preference weight is indicated by ‘Mk’ because it can vary according to the geographical location of a content reproducing apparatus. For reference, if the second preference weight varies according to scheduling target content, it may be changed to ‘Mjk.’

An operator (\textcircled{x}) is an arbitrary operator. The content scheduling apparatus 100 may determine the operator in consideration of the relationship between a first preference weight Wijk, the second preference weight Mk, and a priority Rj of scheduling target content.

The content scheduling apparatus 100 may also determine the third preference weight, which is a preference that can vary according to hardware features of a content reproducing apparatus, and reflect the third preference weight in the objective function. For example, factors that determine the third preference weight may be information such as the type of a display of a content reproducing apparatus, the size of the display, the resolution of the display, and whether the sound is reproduced. This reflects the fact that the effect of content exposure to a target audience is great when the size of the display screen is large and the resolution of the display screen is high and when even the sound is reproduced.

The third preference weight may be reflected in the objective function of the linear programming model in the same form as the second preference weight Mk. Alternatively, if the third preference weight varies according to scheduling target content, it may be reflected in the objective function in the form of ‘Mjk.’ The fact that the third preference weight varies according to scheduling target content indicates that the exposure effect of the scheduling target content can vary according to hardware features of a content reproducing apparatus.

Until now, the linear programming model that additionally includes the second preference weight and the third preference weight has been described. Considering that an optimal scheduling combination is greatly affected by the accuracy of weights which are coefficients of an objective function of a linear programming model, the accuracy of the scheduling result can be further improved by calculating accurate weights according to the above-described method.

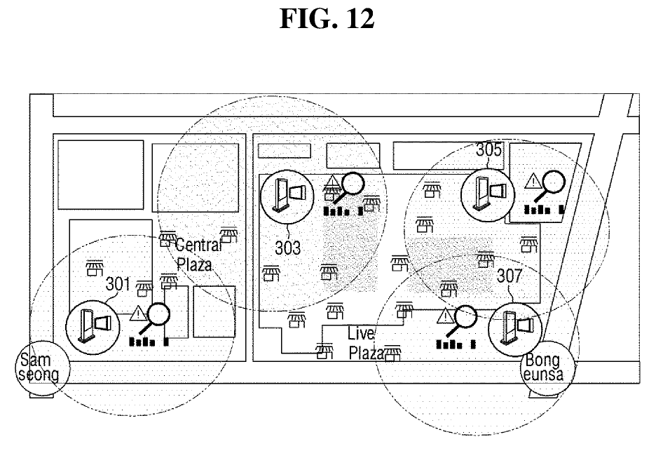

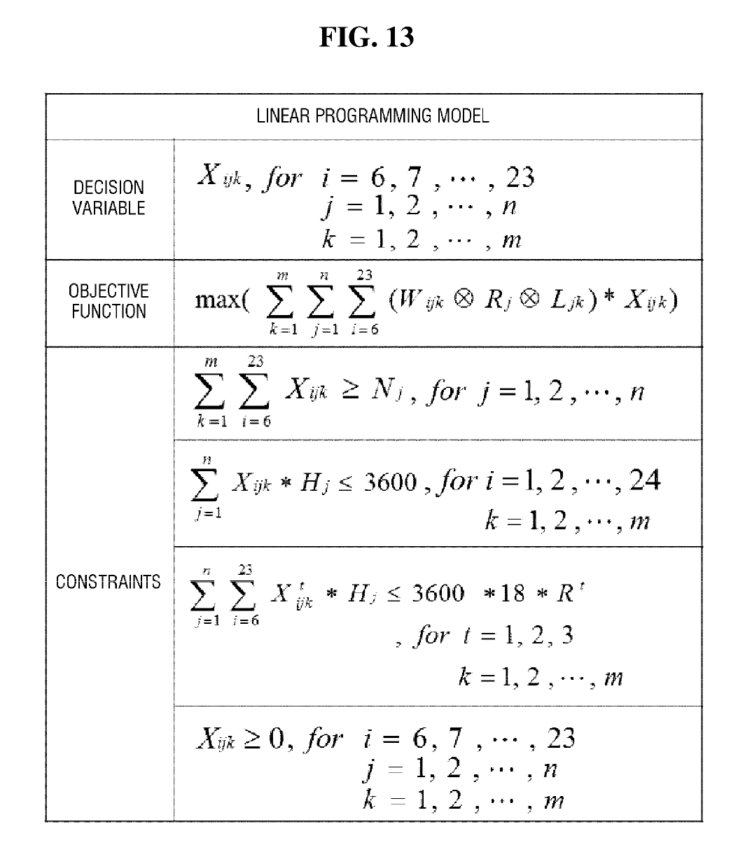

Next, a linear programming model for preferentially allocating relevant content by reflecting information about nearby stores will be described with reference to FIGS. 12 and 13.

The content scheduling apparatus 100 can further improve the effect of providing content by scheduling content related to stores around a content reproducing apparatus to be preferentially placed in a highly preferred time slot. For example, in the content providing system illustrated in FIG. 9A, advertisement content related to stores around each content reproducing apparatus 301, 303, 305 or 307 may be scheduled to be reproduced at a time when the floating population of a target audience is large. Therefore, the overall sales of the shopping mall can be improved.

In order to perform scheduling that reflects nearby store information, the content scheduling apparatus 100 may determine a weight (hereinafter, referred to as a ‘relevance weight’) indicating the relevance of scheduling target content to nearby stores and reflect the relevance weight in an objective function of a linear programming model.

For example, as illustrated in FIG. 12, the content scheduling apparatus 100 may set the range of stores around each content reproducing apparatus 301, 303, 305 or 307 based on a geographical location where each content reproducing apparatus 301, 303, 305 or 307 is installed. Alternatively, the range of nearby stores may be preset according to implementation method or may be set as information such as a list of nearby stores, instead of range. The range may be set differently for each content reproducing apparatus.

The content scheduling apparatus 100 may obtain information about stores within a preset range from a geographical location where each content reproducing apparatuses 301, 303, 305 or 307 is installed and determine the relevance weight based on the relevance of scheduling target content to the store information. The store information may include location information of the stores and brand information of the stores.

The content scheduling apparatus 100 may give a preset relevance weight to scheduling target content related to the brand of a store. In addition, the content scheduling apparatus 100 may determine a different relevance weight using the distance between the geographical location of each content reproducing apparatus 301, 303, 305 or 307 and the location of the store. For example, the content scheduling apparatus 100 may give a higher relevance weight to scheduling target content related to a store which is located close to the geographical location of each content reproducing apparatus 301, 303, 305 or 307.

FIG. 13 illustrates a linear programming model that reflects the relevance weight in the linear programming model of FIG. 11. A decision variable Xijk and constraints of the linear programming model of FIG. 13 are the same as those of the linear programming model illustrated in FIG. 11, and thus a description of the decision variable Xijk and the constraints will be omitted.

Referring to an objective function of the linear programming model illustrated in FIG. 13, a weight Ljk for relevant content denotes a relevance weight that a piece of scheduling target content has for a ‘k^{th}’ content reproducing apparatus. In FIG. 14, the weight for relevant content is indicated by ‘Ljk’ based on the assumption that the weight for relevant content is the same in each time slot. However, if the weight for relevant content is different in each time slot, it may be changed to ‘Lijk.’

An operator (\textcircled{x}) is an arbitrary operator. The content scheduling apparatus 100 may determine the operator in consideration of the relationship between a first preference weight Wijk, priority information Rj of scheduling target content, and the weight information Ljk for relevant content.

For example, the content scheduling apparatus 100 may determine the operator to be a ‘multiplication operator.’ That is, the content scheduling apparatus 100 may set a function, which maximizes the sum of values obtained by multiplying the first preference weight Wijk, the priority Rj of scheduling target content, the relevance weight Ljk and the decision variable Xijk, as an objective function. Alternatively, the content scheduling apparatus 100 may determine a function, which maximizes the sum of values obtained by multiplying each weight and priority by an appropriate constant to adjust the ratio of reflection of the first preference weight Wijk, the priority Rj of scheduling target content and the relevance weight Ljk and then multiplying the above multiplication result by the decision variable Xijk, as the objective function.

Alternatively, the content scheduling apparatus 100 may set the objective function by using a second preference weight or a third preference weight in addition to the first preference weight Wijk. Alternatively, the content scheduling apparatus 100 may set the objective function by combining various preference weights, priorities of scheduling target content and relevance weights described above in various ways.

The content scheduling apparatus 100 can perform scheduling in the multi-content reproducing apparatus environment in consideration of the first preference weight Wijk, the priority Rj of scheduling target content and the relevance weight Wjk by calculating an optimal solution or approximate optimal solution of the linear programming model illustrated in FIG. 13.

Until now, the linear programming model that additionally uses a relevance weight has been described. According to the above-described linear programming model, the content scheduling apparatus 100 can preferentially place scheduling target content elated to nearby stores in a highly preferred time slot. Therefore, the effect of content related to nearby stores can be improved.

The inventive concept described above with reference to FIGS. 5 through 13 can be embodied as computer-readable code on a computer-readable medium. The computer-readable medium may be, for example, a removable recording medium (a CD, a. DVD, a blu-ray disc, a USB storage device, or a removable hard disc) or a fixed recording medium (a ROM, a RAM, or a computer-embedded hard disc). The computer program recorded on the computer-readable recording medium may be transmitted to another computing device through a network, such as the Internet, to be installed and used in the computing device.

According to the inventive concept described above, a preference weight is determined based on the number of floating population of a target audience, and content scheduling is performed using the preference weight. Therefore,the effect of content exposure to the target audience can be improved.

According to the inventive concept described above, the preference weight is determined more accurately based on features (such as an entrance and crossroads) of a geographical location where a content reproducing apparatus is installed and hardware features of the content reproduction apparatus in addition to the number of floating population of the target audience, and the content scheduling is performed using the preference weight. Therefore, the effect of content exposure to the target audience can be further improved.

In addition, the improved effect of content exposure to the target audience increases the profit of a content providing entity. For example, if scheduling target content is advertisement content, the e Tee of advertisement exposure the target audience is improved. Accordingly, the profit of an advertising entity can be improved. Furthermore, since the advertising contract cost s increased according to the improvement of the advertising effect, the profit of an operating entity of the content reproducing apparatus (a ‘content reproducing entity’) is also increased.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

However, the effects of the inventive concept are not restricted to the one set forth herein. The above and other effects of the inventive concept will become more apparent to one of daily skill in the art to which the inventive concept pertains by referencing the claims.

What is claimed is:

1. A content scheduling method for a plurality of content reproduction apparatuses located at different geographical locations, the method comprising:
obtaining a total play count of target content;
determining a plurality of weight values of the target content, each weight value of the plurality of weight values indicating a preference for the target content with respect to each content reproduction apparatus of the plurality of content reproduction apparatuses, wherein the plurality of weight values are different for at least some of the plurality of content reproduction apparatuses;
generating a linear programming model based on the total play count and the plurality of weight values; and
determining, via a processor, a play count of the target content in each time slot of a plurality of time slots for the each content reproduction apparatus based on the linear programming model.

2. The method of claim 1, wherein the plurality of weight values indicate the preference for the target content with respect to the each content reproduction apparatus and further with respect to the each time slot,
wherein the plurality of weight values are different for at least some of the plurality of time slots, and
wherein the plurality of weight values are determined based on a size of a floating population of a target audience for the target content, the size of the floating population representing a number of people who visited or pass by a specific geographical location.

3. The method of claim 2, wherein the determining the plurality of weight values comprises correcting the each weight value based on a waiting time of the target audience located within a predetermined range from a geographical location where the each content reproduction apparatus is installed.

4. The method of claim 1, wherein the plurality of weight values are different for the at least some of the plurality of content reproduction apparatuses according to features of a geographical location where the each content reproduction apparatus is installed, and wherein the features of the geographical location are irrelevant to a change in a size of a floating population at the geographical location, the size of the floating population representing a number of people who visited or pass by the geographical location.

5. The method of claim 1, wherein the plurality of weight values are different for the at least some of the plurality of content reproduction apparatuses according to hardware features of the each content reproduction apparatus, and wherein the hardware features are irrelevant to a geographical location where the each content reproduction apparatus is installed and a change in a size of a floating population at the geographical location, the size of the floating population representing a number of people who visited or pass by the geographical location.

6. The method of claim 1, wherein the determining the plurality of weight values comprises:
dividing an area where the plurality of content reproduction apparatuses are installed into a plurality of areas based on a size of a floating population, the size of the floating population representing a number of people who visited or pass by the plurality of areas;
assigning a predetermined weight value to each of the plurality of areas;
determining a first weight value of the target content for a first content reproduction apparatus located in a first area among the plurality of areas using the assigned weight value to the first area; and
determining a second weight value of the target content for a second content reproduction apparatus located in a second area among the plurality of areas using the assigned weight value to the second area reproduction.

7. The method of claim 6, wherein locations and sizes of the plurality of areas are updated according to a change in the size of the floating population.

8. The method of claim 1, wherein the each weight value indicates the preference for the target content with respect to the each content reproduction apparatus and further with respect to the each time slot of the each content reproduction apparatus,
wherein the each weight value comprises at least one of a first preference weight which has different values for at least some of the plurality of time slots, a second preference weight which has different values for at least some of the plurality of content reproduction apparatuses according to features of a geographical location where the each content reproduction apparatus is installed, and a third preference weight which has different values for at least some of the plurality of content reproduction apparatuses according to hardware features of the each content reproduction apparatus, and
wherein the generating the linear programming model comprises:
setting the play count of the target content in the each time slot for the each content reproduction apparatus as a decision variable of the linear programming model;
setting an objective function of the linear programming model based on the plurality of weight values and the decision variable; and
setting constraints of the linear programming model based on the total play count of the target content and the decision variable.

9. The method of claim 8, wherein the objective function maximizes a sum of values obtained by multiplying the plurality of weight values by the decision variable.

10. The method of claim 1, further comprising:
obtaining information about stores located within a preset range from a geographical location where the each content reproduction apparatus is installed, wherein the information about the stores comprises brands of the stores;
determining a portion of the target content related to the brands of the stores; and
determining a relevance weight value of the determined portion of the target content for the each content reproduction apparatus,
wherein the generating the linear programming model comprises:
setting the play count of the target content in the each time slot for the each content reproduction apparatus as a decision variable of the linear programming model; and
setting an objective function of the linear programming model based on the relevance weight value, the plurality of weight values, and the decision variable.

11. The method of claim 10, wherein the objective function of the linear programming model maximizes a sum of values obtained by multiplying the plurality of weight values by the relevance weight value and the decision variable.

12. A content scheduling apparatus comprising:
at least one processor;
a network interface configured to communicate with a plurality of content reproduction apparatuses;
a memory configured to load a computer program to be executed by the at least one processor; and
a storage configured to store the computer program which, when executed by the at least one processor, causes the at least one processor to perform operations comprising:
obtaining a total play count of target content;
determining a plurality of weight values of the target content, each weight value of the plurality of weight values indicating a preference for the target content with respect to each content reproduction apparatus of the plurality of content reproduction apparatuses, wherein the plurality of weight values are different for at least some of the plurality of content reproduction apparatuses;
generating a linear programming model based on the total play count and the plurality of weight values; and
determining a play count of the target content in the each time slot for the each content reproduction apparatus based on the linear programming model.

13. A computer-readable storage medium storing instructions which, when executed by a processor, cause the processor to perform operations comprising:
obtaining a total play count of target content;
determining a plurality of weight values of the target content, each weight value of the plurality of weight values indicating a preference for the target content with respect to each content reproduction apparatus of the plurality of content reproduction apparatuses, wherein the plurality of weight values are different for at least some of the plurality of content reproduction apparatuses;
generating a linear programming model based on the total play count and the plurality of weight values; and
determining a play count of the target content in the each time slot for the each content reproduction apparatus based on the linear programming model.
